(19) United States
(12) Patent Application Publication
(10) Pub. No.: US 2026/0017939 A1
(43) Pub. Date: Jan. 15, 2026

(54) RESOURCE-EFFICIENT GENERATIVE MACHINE LEARNING

(71) Applicant: ADOBE INC., San Jose, CA (US)

(72) Inventors: Qizheng Yang, Amherst, MA (US); Haoliang Wang, Sunnyvale, CA (US); Kanak Mahadik, San Jose, CA (US)

(21) Appl. No.: 18/767,044

(22) Filed: Jul. 9, 2024

(51) Int. Cl. G06V 10/82; G06V 10/762

(52) U.S. Cl. CPC G06V 10/82; G06V 10/762

(57) ABSTRACT

A method, apparatus, non-transitory computer readable medium, and system for generative machine learning include obtaining an input prompt, generating a complexity value of the input prompt, where the complexity value corresponds to an amount of resources for a generative machine learning model to achieve a target quality level based on the input prompt, allocating resources of the generative machine learning model based on the complexity value, and generating a synthetic output based on the input prompt using the allocated resources, wherein the synthetic output has the target quality level.

### BACKGROUND

The following relates generally to machine learning and more specifically to resource-efficient generative machine learning. Machine learning is an information processing field in which algorithms or models such as artificial neural networks are trained to make predictive outputs in response to input data without being specifically programmed to do so.

For example, a generative machine learning model can be trained to generate a synthetic output (such as an image, text, audio, or video) based on input data, where the synthetic output is a prediction of what the machine learning model thinks the input data describes. However, in some cases, generative machine learning is computationally and resource intensive.

### SUMMARY

Embodiments of the present disclosure provide resource-efficient generative machine learning. According to some aspects, a generative system allocates resources to a generative machine learning model according to a determined complexity of an input prompt, and generates a synthetic output using the generative machine learning model and the allocated resources.

By allocating resources of the generative machine learning model according to the determined complexity of the input prompt, the generative machine learning model avoids using excess resources for the generative task, and the synthetic output is therefore efficiently generated.

A method, apparatus, non-transitory computer readable medium, and system for generative machine learning are described. One or more aspects of the method, apparatus, non-transitory computer readable medium, and system include obtaining an input prompt; generating, using a classifier network, a complexity value of the input prompt, wherein the complexity value corresponds to an amount of resources for a generative machine learning model to achieve a target quality level based on the input prompt; allocating resources of the generative machine learning model based on the complexity value; and generating, using the generative machine learning model, a synthetic output based on the input prompt using the allocated resources, wherein the synthetic output has the target quality level.

A method, apparatus, non-transitory computer readable medium, and system for training a machine learning model are described. One or more aspects of the method, apparatus, non-transitory computer readable medium, and system include obtaining a training set including a training prompt; generating, using a generative machine learning model, a synthetic output based on the training prompt; and training, using the training set and the synthetic output, a classifier network to generate a complexity value of an input prompt, wherein the complexity value corresponds to an amount of resources for a generative machine learning model to achieve a target quality level based on the input prompt.

An apparatus and system for generative machine learning are described. One or more aspects of the apparatus and system include at least one memory; at least one processor executing instructions stored in the at least one memory; a classifier network comprising classification parameters stored in the at least one memory, the classifier network trained to generate a complexity value of an input prompt, wherein the complexity value corresponds to an amount of resources to achieve a target quality level based on the input prompt; an allocation component configured to allocate resources based on the complexity value; and a generative machine learning model comprising generative parameters stored in the at least one memory, the generative machine learning model trained to generate a synthetic output based on the input prompt using the allocated resources, wherein the synthetic output has the target quality level.

### BRIEF DESCRIPTION OF THE DRAWINGS

FIG. 1 shows an example of a generative system according to aspects of the present disclosure.

FIG. 2 shows an example of a method for generating a synthetic image according to aspects of the present disclosure.

FIG. 3 shows an example of a generative apparatus according to aspects of the present disclosure.

FIG. 4 shows an example of a guided diffusion architecture according to aspects of the present disclosure.

FIG. 5 shows an example of a U-Net according to aspects of the present disclosure.

FIG. 6 shows an example of a transformer according to aspects of the present disclosure.

FIG. 7 shows an example of data flow in a generative system according to aspects of the present disclosure.

FIG. 8 shows an example of a method for generating a synthetic output according to aspects of the present disclosure.

FIG. 9 shows an example of diffusion processes according to aspects of the present disclosure.

FIG. 10 shows an example of a method for training a machine learning model according to aspects of the present disclosure.

FIG. 11 shows an example of data flow for training a machine learning model according to aspects of the present disclosure.

FIG. 12 shows an example of a graph of quality values versus resource allocations according to aspects of the present disclosure.

FIG. 13 shows an example of a computing device according to aspects of the present disclosure.

### DETAILED DESCRIPTION

A generative machine learning model can be trained to generate a synthetic output (such as an image, text, audio, or video) based on input data, where the synthetic output is a prediction of what the machine learning model thinks the input data describes. However, conventional generative machine learning models use an equal amount or number of resources (such as a number of image generation steps, a number of processors, a number of parameters or layers of the model), etc. to compute each different synthetic output based on each input, regardless of a complexity of each different input.

Conventional generative systems may attempt to reduce latency and increase throughput of comparative generative machine learning models by throttling resource usage of the comparative generative machine learning models. However, such a throttling is applied equally for all inputs, which can result in a significant reduction in quality of some outputs generated by the comparative generative machine learning models.

In an example, a conventional diffusion model uses a reverse diffusion process including a number of diffusion time steps to iteratively generate a final image based on a text prompt, where an image is generated at each diffusion time step of the reverse diffusion process, and the images generated at each diffusion time step may differ significantly from each other (with a larger difference present among earlier diffusion time steps than later diffusion time steps). If a conventional system were to attempt to increase an efficiency of the conventional diffusion model by using fewer diffusion time steps to generate images for each input text prompt, some final images would not be of acceptable quality and/or would not depict content intended by their respective text prompts as accurately as they would have had the full number of diffusion time steps been used, because text prompts vary in complexity.

Furthermore, some conventional approaches to ANN serving focus on GPU utilization, throughput, and cost reduction through techniques such as adaptive batching, spatio-temporal sharing, and model variant selection. However, these methods primarily address independent prediction tasks and general ANN models without considering machine learning pipelines that include complex models for generative tasks, which may result in suboptimal GPU resource utilization and delayed response due to workload fluctuations.

Embodiments of the present disclosure provide resource-efficient generative machine learning. According to some aspects, a generative system allocates resources to a generative machine learning model according to a determined complexity of an input prompt, and generates a synthetic output using the generative machine learning model and the allocated resources.

By allocating resources of the generative machine learning model according to the determined complexity of the input prompt, the generative machine learning model avoids using excess resources for the generative task, and the synthetic output is therefore efficiently generated without a significant decrease in quality of the synthetic output.

An example of the generative system is used in an image generation context. For example, a user provides a text prompt describing an element of an image to be generated to the generative system. The generative system uses a classifier network to determine that a generative machine learning model should use, e.g., 40 diffusion time steps to generate a synthetic image of acceptable quality based on the input prompt. Based on the determination, the generative system uses the generative machine learning model and 40 diffusion time steps to generate the synthetic output. In an alternative, a conventional generative machine learning model may have used a standard, greater number of diffusion time steps (e.g., 50) to generate the synthetic output. Therefore, the generative system reduces a latency and increases a throughput of the generative machine learning model over the conventional machine learning model.

In the example, the generative system may receive a set of text prompts and determine that the generative machine learning model should use a same number of diffusion time steps to generate images based on a subset of the text prompts. The generative system may then process the subset of text prompts through the generative machine learning model in a single batch, thereby maintaining a similar overall quality of the synthetic image outputs while decreasing an overall latency and increasing an overall throughput of the generative machine learning model, so that the generative system can keep pace with an inflow of the set of text prompts.

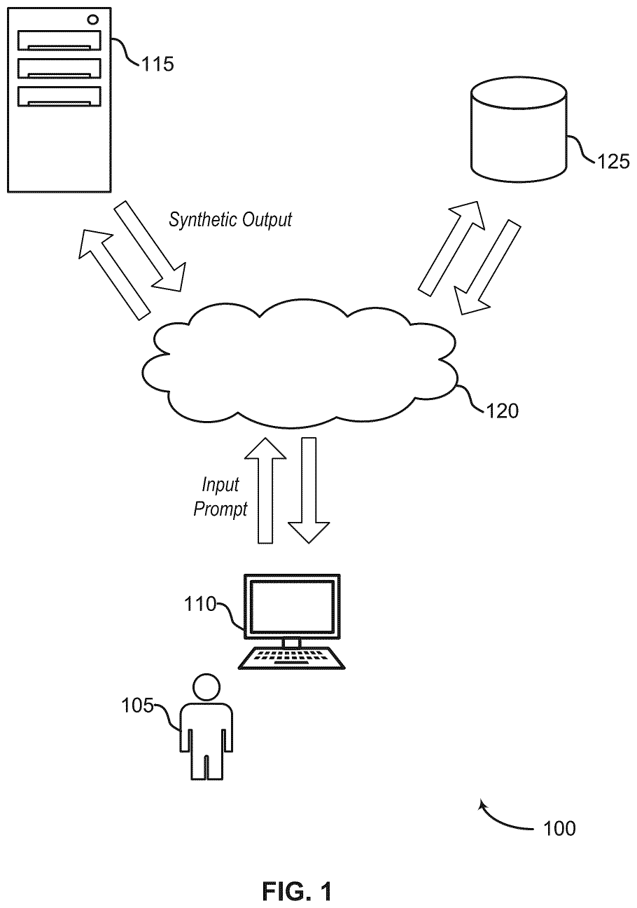

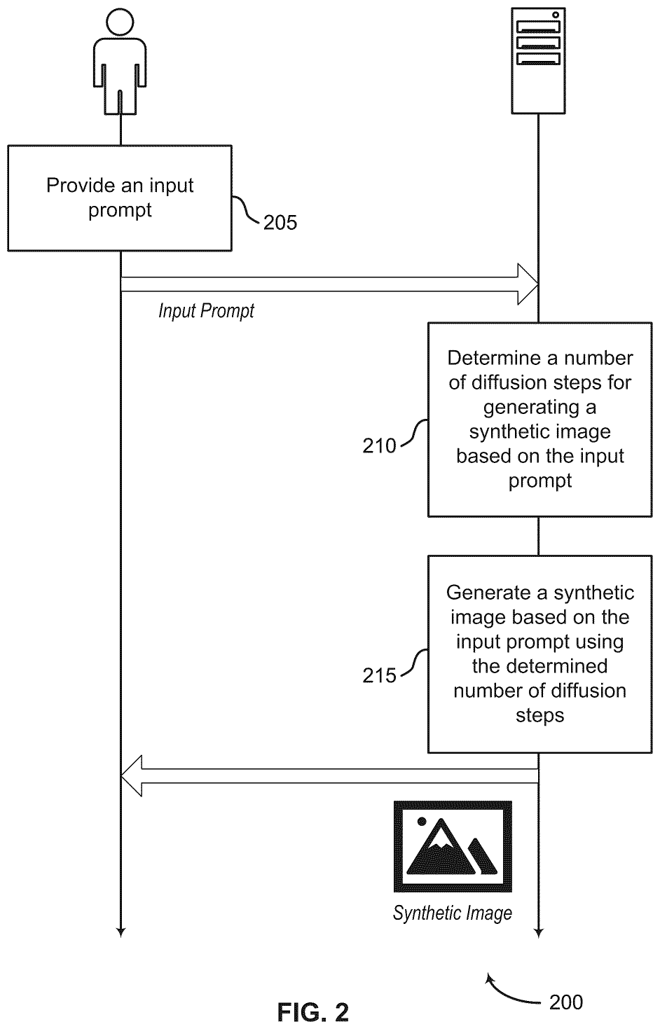

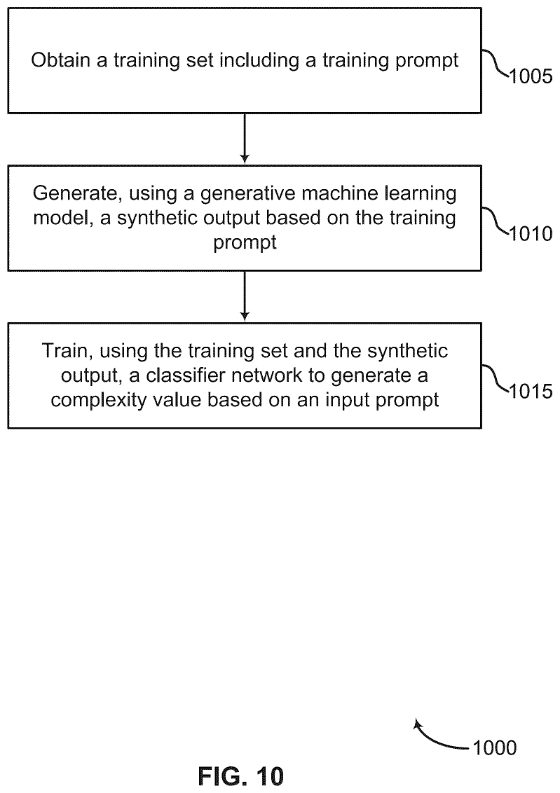

Further example applications of the present disclosure in the image generation context are provided with reference to FIG. 2. Details regarding the architecture of the generative system are provided with reference to FIGS. 1, 3-7, and 13. Examples of a process for generative machine learning are provided with reference to FIGS. 2 and 8-9. Examples of a process for training a machine learning model are provided with reference to FIGS. 10-12.

Embodiments of the present disclosure improve upon conventional generative machine learning systems by making an output generation process more efficient. For example, some embodiments allocate resources of a generative machine learning model according to the complexity of an input prompt, thereby minimizing the resources used while maintaining output quality and fidelity to the input prompt. Some embodiments achieve this efficiency by determining a complexity value for the input prompt using a classifier network, allocating resources of the generative machine learning model according to the complexity value, and generating the output based on the input prompt using the allocated resources.

By contrast, conventional generative machine learning systems do not allocate resource requirements based on each input prompt, thereby generating outputs using a large number of computational inputs or having inferior quality and fidelity to the input prompts.

### Generative System

A system and an apparatus for generative machine learning are described with reference to FIGS. 1-7. One or more aspects of the system and the apparatus include at least one memory; at least one processor executing instructions stored in the at least one memory; a classifier network comprising classification parameters stored in the at least one memory, the classifier network trained to generate a complexity value of an input prompt, wherein the complexity value corresponds to an amount of resources to achieve a target quality level based on the input prompt; an allocation component configured to allocate resources based on the complexity value; and a generative machine learning model comprising generative parameters stored in the at least one memory, the generative machine learning model trained to generate a synthetic output based on the input prompt using the allocated resources, wherein the synthetic output has the target quality level.

In some aspects, the generative machine learning model comprises an image generation model, and the allocated resources comprise a number of image generation steps. In some aspects, the generative machine learning model comprises a configurable number of parameters, wherein the allocated resources indicates a value for the configurable number of parameters. Some examples of the system and the apparatus further include a plurality of processors, wherein the allocated resources comprises one or more of the plurality of processors.

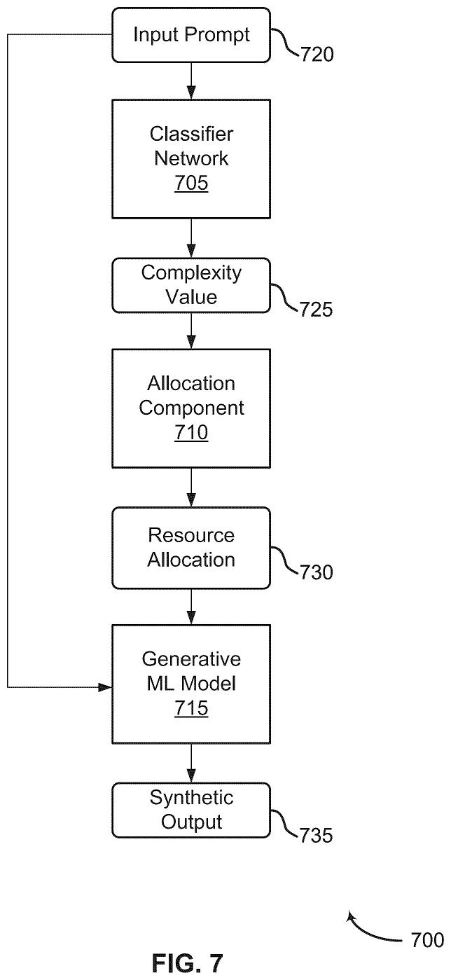

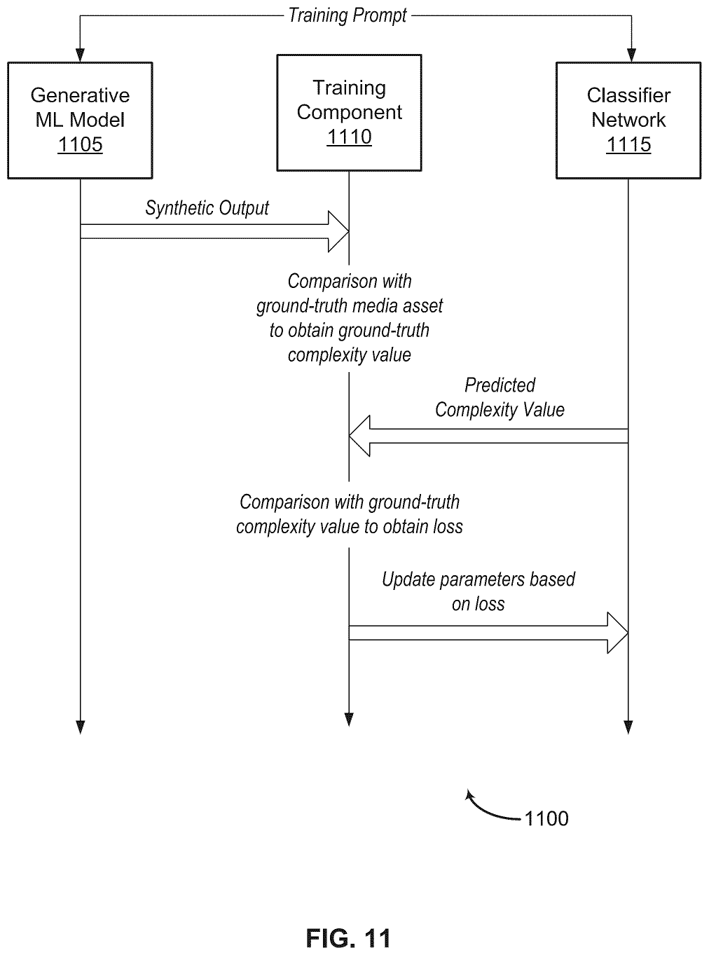

FIG. 1 shows an example of a generative system 100 according to aspects of the present disclosure. Generative system 100 is an example of, or includes aspects of, the corresponding element described with reference to FIGS. 7 and 11. The example shown includes user 105, user device 110, generative apparatus 115, cloud 120, and database 125.

Referring to FIG. 1, according to some aspects, user 105 provides an input prompt to generative apparatus 115 via a user interface displayed on user device 110 by generative apparatus 115. In some cases, the input prompt is a text prompt comprising text. In some cases, generative apparatus 115 generates a complexity value for the input prompt, and allocates resources for a generative machine learning model based on the complexity value. In some cases, generative apparatus 115 generates a synthetic output based on the input prompt using the allocated resources. In some cases, generative apparatus 115 displays the synthetic output to user 105 via the user interface.

As used herein, an “input prompt” refers to information that is intended to guide a generative process of a generative machine learning model. For example, in some cases, the input prompt is a text prompt including a text string, or an image prompt including an image, which describes intended content or an intended characteristic (e.g., an element) of an intended output of the generative machine learning model.

As used herein, a “synthetic output” is an output generated by the generative machine learning model. In some cases, a synthetic output comprises text, an image, audio, a video, or a combination thereof.

As used herein, in some cases, a “complexity value” refers to an indication of resources that a generative machine learning model uses to generate a synthetic output based on the input prompt. In some cases, a complexity value comprises a label.

In some cases, the “resources” of the generative machine learning model include a particular number of generative steps, such as diffusion time steps of a reverse diffusion process. In some cases, the resources of the generative machine learning model relate to computing power. For example, in some cases, the resources of the generative machine learning model include a number of processors to be used to generate the synthetic output, or an identification of a particular processor. In some cases, the resources of the generative machine learning model relate to a network size or parameters of the generative machine learning model. For example, in some cases, the resources of the generative machine learning model include a number of layers of the generative machine learning model used to generate the synthetic output. In some cases, the resources of the generative machine learning model relate to a selection of the generative machine learning model from among a set of candidate machine learning models.

As used herein, in some cases, “allocating resources” refers to identifying resources for the generative machine learning model to use, and instructing the generative machine learning model (for example, by adjusting parameters and/or hyperparameters of the generative machine learning model) to generate the synthetic output using the identified resources.

As used herein, in some cases, a “target quality level” refers to a measurement of a quality of a synthetic output. In some cases, the target quality level is a comparative measurement with respect to a quality level of a hypothetical synthetic output that could be generated based on the input prompt using unlimited computing resources.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by generative apparatus 115. In some aspects, the user interface allows information (such as an image, a prompt, user inputs, etc.) to be communicated between user 105 and generative apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

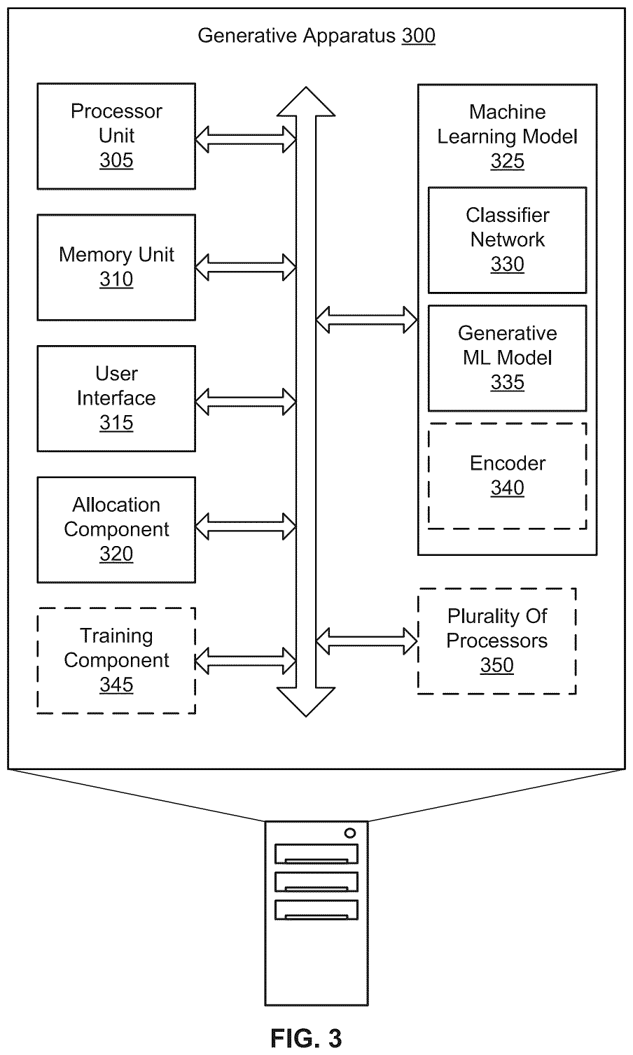

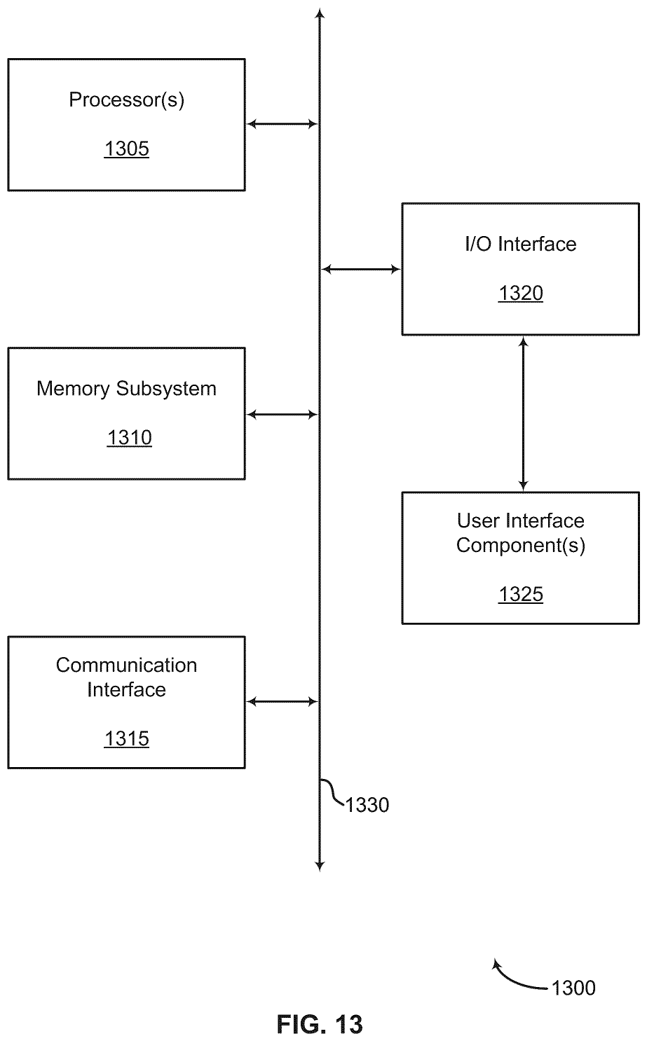

Generative apparatus 115 is an example of, or includes aspects of, the corresponding element described with reference to FIGS. 3 and 13. According to some aspects, generative apparatus 115 includes a computer-implemented network. In some embodiments, the computer-implemented network includes a machine learning model (such as the machine learning model described with reference to FIG. 3). In some embodiments, generative apparatus 115 also includes one or more processors, a memory subsystem, a communication interface, an I/O interface, one or more user interface components, and a bus as described with reference to FIG. 13. Additionally, in some embodiments, generative apparatus 115 communicates with user device 110 and database 125 via cloud 120.

In some cases, generative apparatus 115 is implemented on a server. A server provides one or more functions to users linked by way of one or more of various networks, such as cloud 120. In some cases, the server includes a single microprocessor board that includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

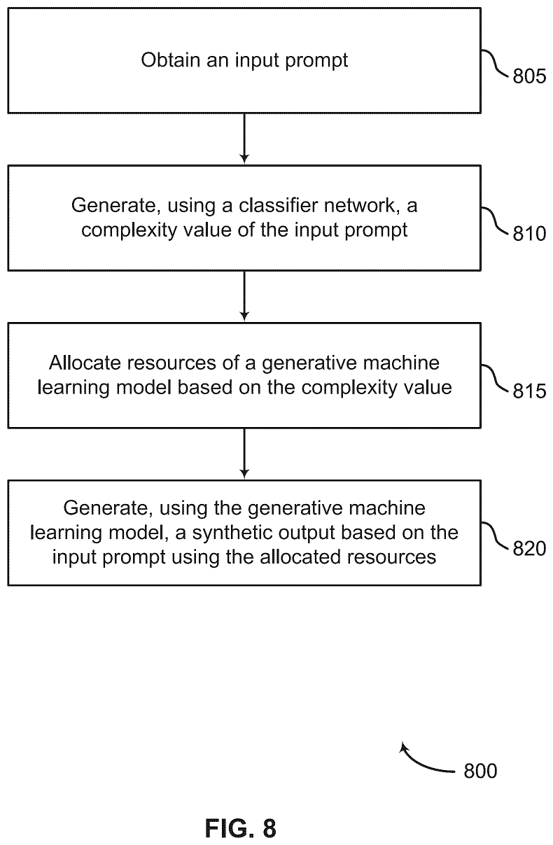

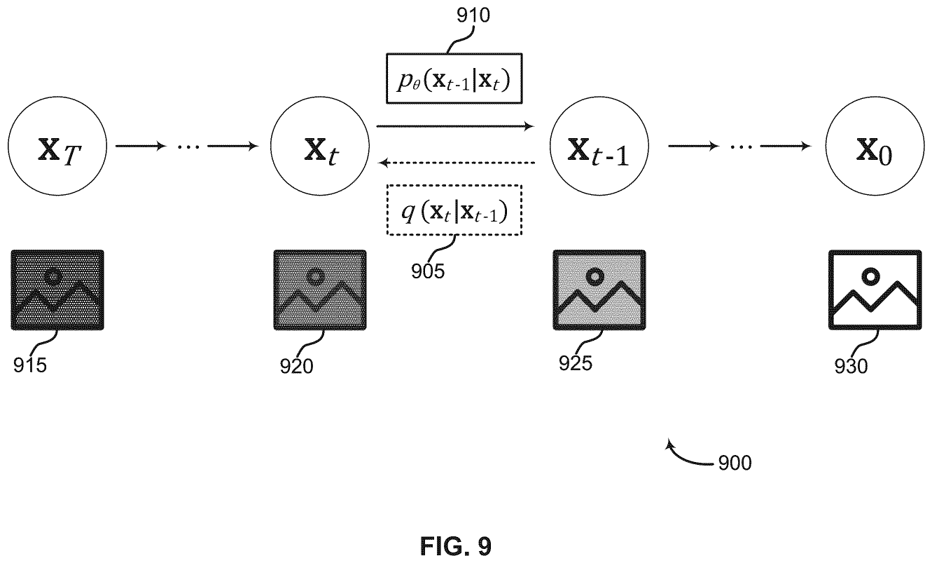

Further detail regarding the architecture of generative apparatus 115 is provided with reference to FIGS. 3-7 and 13. Further detail regarding a process for generating a synthetic output is provided with reference to FIGS. 8-9. Examples of a process for training a machine learning model are provided with reference to FIGS. 10-12.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if the server has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, generative apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to generative apparatus 115 and communicates with generative apparatus 115 via cloud 120. According to some aspects, database 125 is included in generative apparatus 115.

FIG. 2 shows an example of a method 200 for generating a synthetic image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, an aspect of the present disclosure is used in an image generation context. In an example, a user provides a text prompt to a generative apparatus (such as the generative apparatus described with reference to FIGS. 1, 3, and 13), where the text prompt describes content and/or a visual characteristic of an image to be generated by the generative apparatus.

In the example, the generative apparatus uses a classifier network (such as the classifier network described with reference to FIGS. 3, 7, and 11) to generate a complexity value comprising an indication of a number of diffusion time steps to use to generate an image of desirable quality based on the input prompt. In the example, the generative apparatus generates the image based on the input prompt using a diffusion process performed by a generative machine learning model (such as the generative machine learning model described with reference to FIGS. 3-7 and 11) with the determined number of diffusion time steps.

According to some aspects, by allocating resources (a number of diffusion time steps) to the generative machine learning model based on the complexity value for the input prompt, the generative apparatus increases an efficiency of the image generation process without sacrificing the quality of the generated image.

At operation 205, a user provides an input prompt. In some cases, the operations of this step refer to, or may be performed by, a user as described with reference to FIG. 1. In an example, the user provides the input prompt (e.g., a text prompt) to the generative apparatus via a user interface displayed on a user device (such as the user device described with reference to FIG. 1) by the generative apparatus. In some cases, the user interface comprises a graphical user interface, a text-based user interface, or a combination thereof.

At operation 210, the system determines a number of diffusion time steps for generating a synthetic image based on the input prompt. In some cases, the operations of this step refer to, or may be performed by, a generative apparatus as described with reference to FIGS. 1, 3, and 13. In an example, the classifier network predicts a number of diffusion time steps that the generative machine learning model should use for generating a synthetic image based on the input prompt.

At operation 215, the system generates a synthetic image based on the input prompt using the determined number of diffusion time steps. In some cases, the operations of this step refer to, or may be performed by, a generative apparatus as described with reference to FIGS. 1, 3, and 13. In an example, the generative apparatus instructs the generative machine learning model to generate the synthetic image using the predicted number of diffusion time steps, where the image generation process is guided by the image generation prompt and where the diffusion time steps are an allocated resource, and the generative machine learning model generates the synthetic image based on the instruction. In some cases, the generative apparatus displays the synthetic image to the user via the user interface.

FIG. 3 shows an example of a generative apparatus 300 according to aspects of the present disclosure. Generative apparatus 300 is an example of, or includes aspects of, the corresponding element described with reference to FIGS. 1 and 13. In one aspect, generative apparatus 300 includes processor unit 305, memory unit 310, user interface 315, allocation component 320, machine learning model 325, training component 345, and plurality of processors 350.

According to some aspects, processor unit 305 comprises one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 305 is configured to operate a memory array using a memory controller. In other cases, a memory controller is integrated into processor unit 305. In some cases, processor unit 305 is configured to execute computer-readable instructions stored in memory unit 310 to perform various functions. In some aspects, processor unit 305 includes special purpose components for modem processing, baseband processing, digital signal processing, or transmission processing. According to some aspects, processor unit 305 comprises the one or more processors described with reference to FIG. 13.

According to some aspects, memory unit 310 comprises one or more memory components coupled with the one or more processors. In some cases, memory unit 310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 305 to perform various functions described herein.

In some cases, memory unit 310 includes a basic input/output system (BIOS) that controls basic hardware or software operations, such as an interaction with peripheral components or devices. In some cases, memory unit 310 includes a memory controller that operates memory cells of memory unit 310. For example, the memory controller may include a row decoder, column decoder, or both. In some cases, memory cells within memory unit 310 store information in the form of a logical state. According to some aspects, memory unit 310 comprises the memory subsystem described with reference to FIG. 13.

According to some aspects, user interface 315 is implemented as software stored in memory unit 310 and executable by processor unit 305, as firmware, as one or more hardware circuits, or as a combination thereof. According to some aspects, user interface 315 is a graphical user interface (GUI), a text-based user interface, or a combination thereof. According to some aspects, user interface 315 is displayed by generative apparatus 300 on a user device (such as the user device described with reference to FIG. 1). According to some aspects, user interface 315 obtains an input prompt. According to some aspects, user interface 315 displays a synthetic output (for example, a synthetic image).

Allocation component 320 is an example of, or includes aspects of, the corresponding element described with reference to FIG. 7. According to some aspects, allocation component 320 is implemented as software stored in memory unit 310 and executable by processor unit 305, as firmware, as one or more hardware circuits, or as a combination thereof.

According to some aspects, allocation component 320 allocates resources of generative machine learning model 335 based on a complexity value. In some examples, allocating the resources includes determining a diffusion time step based on the complexity value. In some examples, allocating the resources includes determining a size of generative machine learning model 335. In some examples, allocating the resources includes selecting generative machine learning model 335 from among a set of candidate machine learning models. In some examples, allocation component allocating the resources includes selecting a processor for generating the synthetic output. According to some aspects, allocation component 320 is configured to allocate resources based on the complexity value.

According to some aspects, machine learning model 325 includes classifier network 330, generative machine learning model 335, and encoder 340. According to some aspects, machine learning model 325 is implemented as software stored in memory unit 310 and executable by processor unit 305, as firmware, as one or more hardware circuits, or as a combination thereof. According to some aspects, machine learning model 325 comprises machine learning parameters stored in memory unit 310.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, the node processes the signal and then transmits the processed signal to other connected nodes.

In some cases, the signals between nodes comprise real numbers, and the output of each node is computed by a function of the sum of the inputs of each node. In some examples, nodes may determine the output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to increase the accuracy of the result (e.g., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Classifier network 330 is an example of, or includes aspects of, the corresponding element described with reference to FIGS. 7 and 11. According to some aspects, classifier network 330 is implemented as software stored in memory unit 310 and executable by processor unit 305, as firmware, as one or more hardware circuits, or as a combination thereof. According to some aspects, classifier network 330 comprises classification parameters (e.g., machine learning parameters) stored in memory unit 310.

According to some aspects, classifier network 330 is trained to generate a complexity value of an input prompt. In some aspects, the complexity value corresponds to an amount of resources to achieve a target quality level based on the input prompt. In some aspects, classifier network 330 is trained by determining a quality of an output of generative machine learning model 335. In some examples, classifier network 330 generates a predicted complexity value based on the training prompt.

According to some aspects, classifier network 330 comprises a multi-layer perception (MLP) that is trained to classify (e.g., label) an input. In some cases, the MLP includes an input layer, one or more hidden layers, and an output layer. In some cases, the input layer receives the input. In some cases, the hidden layers(s) apply transformations to extract features from the input/outputs of previous hidden layer(s). In some cases, the output layer produces a final output. In some cases, the final output represents a probability distribution for the input over one or more classes.

Generative machine learning model 335 is an example of, or includes aspects of, the corresponding element described with reference to FIGS. 7 and 11. According to some aspects, generative machine learning model 335 is implemented as software stored in memory unit 310 and executable by processor unit 305, as firmware, as one or more hardware circuits, or as a combination thereof. According to some aspects, generative machine learning model 335 comprises generative parameters (e.g., machine learning parameters) stored in memory unit 310. According to some aspects, generative machine learning model 335 is trained to generate a synthetic output based on the input prompt using the allocated resources. In some cases, the synthetic output has the target quality level.

In some examples, generating the synthetic output includes performing a diffusion process based on a noise input, the input prompt, and the diffusion time step. In some cases, the synthetic output includes an image that depicts an element described by the input prompt. In some cases, the allocated resources include a number of image generation steps. In some aspects, a number of the generative parameters is configurable. In some cases, the allocated resources indicates a value for the configurable number of parameters.

According to some aspects, generative machine learning model 335 generates a synthetic output based on a training prompt. In some examples, generative machine learning model 335 generates a set of synthetic outputs based on the training prompt using a set of different resource allocations, respectively.

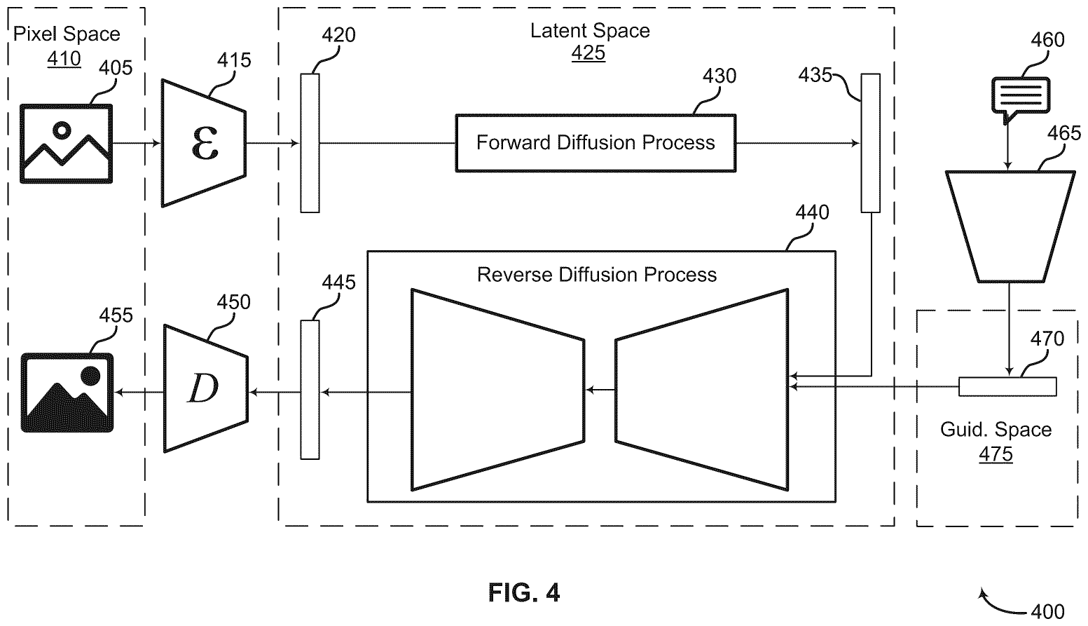

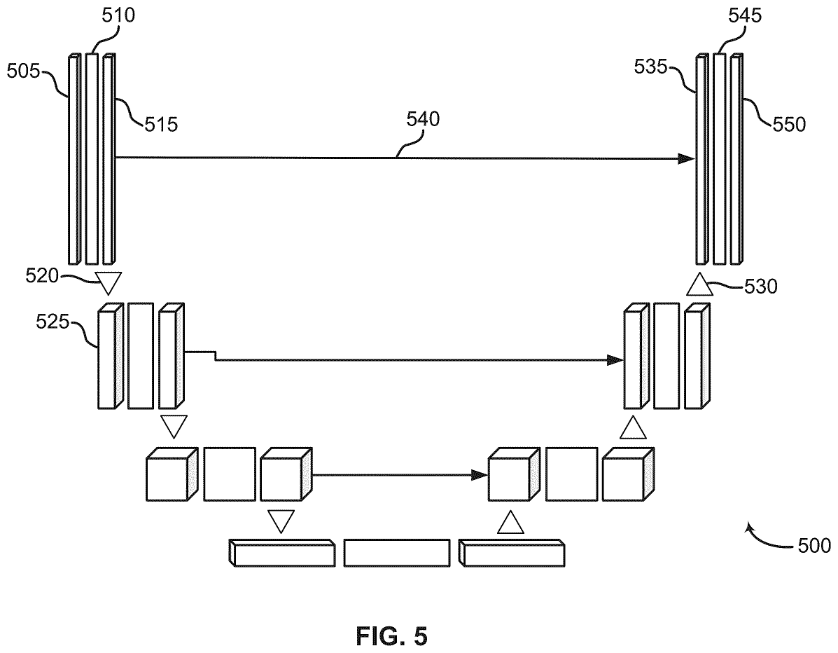

According to some aspects, generative machine learning model 335 comprises an image generation machine learning model. In some cases, the image generation machine learning model comprises a generative adversarial network (GAN). In some cases, the image generation machine learning model comprises a diffusion model, such as the diffusion model described with reference to FIGS. 4-5.

In some cases, a GAN comprises two neural networks (e.g., a generator and a discriminator) that are trained based on a contest with each other. For example, in some cases, the generator learns to generate a candidate by mapping information from a latent space to a data distribution of interest, while the discriminator distinguishes the candidate produced by the generator from a true data distribution of the data distribution of interest. In some cases, the generator's training objective is to increase an error rate of the discriminator by producing novel candidates that the discriminator classifies as “real” (e.g., belonging to the true data distribution).

According to some aspects, generative machine learning model 335 comprises a language generation machine learning model. In some cases, the language generation model comprises a large language model. In some cases, a large language model is an ANN that is trained to understand and generate human-like text based on large amounts of data. In some cases, by analyzing input text data, a large language model learns patterns and structures of human language.

In some cases, the language generation machine learning model includes one or more transformers. In some cases, a transformer comprises one or more ANNs comprising attention mechanisms that enable the transformer to weigh an importance of different words or tokens within a sequence. In some cases, a transformer processes entire sequences simultaneously in parallel, making the transformer highly efficient and allowing the transformer to capture long-range dependencies more effectively.

In some cases, a transformer comprises an encoder-decoder structure. In some cases, the encoder of the transformer processes an input sequence and encodes the input sequence into a set of high-dimensional representations. In some cases, the decoder of the transformer generates an output sequence based on the encoded representations and previously generated tokens. In some cases, the encoder and the decoder are composed of multiple layers of self-attention mechanisms and feed-forward ANNs.

In some cases, the self-attention mechanism allows the transformer to focus on different parts of an input sequence while computing representations for the input sequence. In some cases, the self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures, particularly ANNs employed in natural language processing (NLP) and sequence-to-sequence tasks, which allows an ANN to focus on different parts of an input sequence when making predictions or generating output.

NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. In some cases, these models express the relative probability of multiple answers.

Some sequence models process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

In some cases, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

In some cases, by incorporating an attention mechanism, an ANN dynamically allocates attention to different parts of the input sequence, allowing the ANN to focus on relevant information and capture dependencies across longer distances.

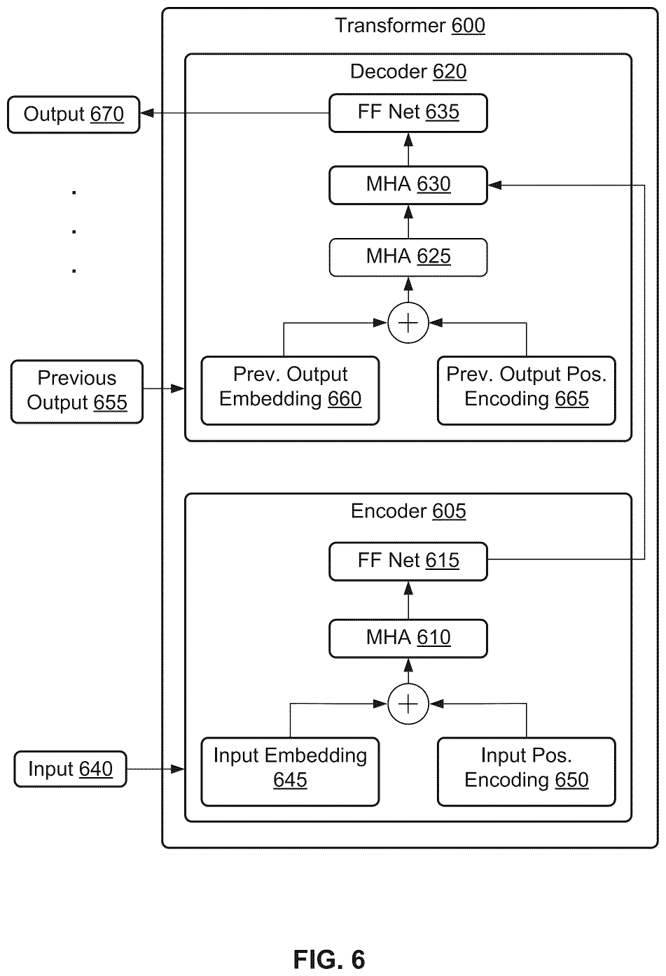

In some cases, calculating attention involves three basic steps. First, a similarity between a query vector Q and a key vector K obtained from the input is computed to generate attention weights. In some cases, similarity functions used for this process include dot product, splice, detector, and the like. Next, a softmax function is used to normalize the attention weights. Finally, the attention weights are weighed together with their corresponding values V. In the context of an attention network, the key K and value V are vectors or matrices that are used to represent the input data. The key K is used to determine which parts of the input the attention mechanism should focus on, while the value V is used to represent the actual data being processed. An example of a transformer is described in further detail with reference to FIG. 6.

According to some aspects, generative machine learning model 335 comprises one or more ANNs trained to generate an audio output based on the input prompt, and the synthetic output comprises the audio output. According to some aspects, generative machine learning model 335 comprises one or more ANNs trained to generate a video output based on the input prompt, and the synthetic output comprises the video output.

According to some aspects, encoder 340 is implemented as software stored in memory unit 310 and executable by processor unit 305, as firmware, as one or more hardware circuits, or as a combination thereof. According to some aspects, encoder 340 comprises encoding parameters (e.g., machine learning parameters) stored in memory unit 310.

According to some aspects, encoder 340 is omitted from generative apparatus 300 and/or machine learning model 325. According to some aspects, encoder 340 is comprised in the generative system in a separate apparatus from generative apparatus 300. According to some aspects, encoder 340 is implemented as software stored in a memory unit of the separate apparatus and executable by a processor unit of the separate apparatus, as firmware of the separate apparatus, as one or more hardware circuits of the separate apparatus, or as a combination thereof. According to some aspects, the encoding parameters are stored in the memory unit of the separate apparatus.

According to some aspects, encoder 340 comprises one or more ANNs trained to generate an embedding based on an input. In some cases, an “embedding” refers to a representation of an input in a lower-dimensional space such that semantic information about the input is more easily captured and analyzed by a machine learning model. For example, in some cases, an embedding is a numerical representation of an object in a continuous vector space in which objects that include similar semantic information to each other correspond to vectors that are numerically similar to and thus “closer” to each other, thereby allowing a similarity between different objects corresponding to different embeddings to be readily determined.

In some cases, encoder 340 comprises a text encoder trained to generate an embedding based on a text input. In some cases, encoder 340 comprises an image encoder trained to generate an embedding based on an image input. In some cases, encoder 340 comprises an audio encoder trained to generate an embedding based on an audio input. In some cases, encoder 340 comprises a video encoder trained to generate an embedding based on a video input. In some cases, encoder 340 comprises a multi-modal encoder trained to generate a multi-modal embedding in a multi-modal embedding space based on the input.

Training component 345 is an example of, or includes aspects of, the corresponding element described with reference to FIG. 10. According to some aspects, training component 345 is implemented as software stored in memory unit 310 and executable by processor unit 305, as firmware, as one or more hardware circuits, or as a combination thereof.

According to some aspects, training component 345 is omitted from generative apparatus 300. According to some aspects, training component 345 is comprised in the generative system in a separate apparatus from generative apparatus 300. According to some aspects, training component 345 is implemented as software stored in a memory unit of the separate apparatus and executable by a processor unit of the separate apparatus, as firmware of the separate apparatus, as one or more hardware circuits of the separate apparatus, or as a combination thereof.

According to some aspects, training component 345 obtains a training set including a training prompt. In some examples, training component 345 trains, using the training set and the synthetic output, classifier network 330 to generate a complexity value based on an input prompt. In some examples, training component 345 compares the predicted complexity value to a ground-truth complexity value for the training prompt.

According to some aspects, training component 345 selects a target resource allocation from among the set of different resource allocations based on the set of synthetic outputs, where classifier network 330 is trained based on the target resource allocation. In some aspects, the target resource allocation includes a diffusion time step, a processor, a network size, or any combination thereof.

In some examples, selecting the target resource allocation includes generating the set of synthetic outputs until a quality condition is satisfied, where the target resource allocation is selected based on resources allocated to generative machine learning model 335 when the quality condition is satisfied. According to some aspects, training component 345 determines a training complexity value based on a target resource allocation.

According to some aspects, training component 345 determines a quality value of the synthetic output, where classifier network 330 is trained based on the quality value. In some examples, determining the quality value includes comparing the synthetic output to a ground-truth media asset. According to some aspects, training component 345 comprises one or more ANNs trained to determine the quality value of the synthetic output.

According to some aspects, training component 345 comprises a convolutional neural network (CNN). In some cases, a convolutional neural network (CNN) is a class of ANN that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During a training process, the filters may be modified so that they activate when they detect a particular feature within the input.

According to some aspects, plurality of processors 350 comprises one or more processors, where a processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. According to some aspects, the allocated resources comprises one or more of the plurality of processors 350.

According to some aspects, plurality of processors 350 is included in processor unit 305. According to some aspects, plurality of processors 350 is omitted from generative apparatus 300. According to some aspects, plurality of processors 350 is comprised in the generative system in a separate apparatus from generative apparatus 300. According to some aspects, generative machine learning model 335 uses at least one of plurality of processors 350 to generate the synthetic output.

FIG. 4 shows an example of a guided diffusion architecture 400 according to aspects of the present disclosure. The example shown includes guided diffusion architecture 400, original image 405, pixel space 410, image encoder 415, original image features 420, latent space 425, forward diffusion process 430, noisy features 435, reverse diffusion process 440, denoised image features 445, image decoder 450, output image 455, prompt 460, encoder 465, guidance features 470, and guidance space 475. According to some aspects, guided diffusion architecture 400 is comprised in a generative apparatus (such as the generative apparatus described with reference to FIGS. 1, 3, and 13).

Diffusion models are a class of generative ANNs that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that a same input results in a same output. Diffusion models may also be characterized by whether noise is added to an image itself, or to image features generated by an encoder, as in latent diffusion.

For example, according to some aspects, image encoder 415 encodes original image 405 from pixel space 410 and generates original image features 420 in latent space 425. According to some aspects, forward diffusion process 430 gradually adds noise to original image features 420 to obtain noisy features 435 in latent space 425 at various noise levels.

According to some aspects, reverse diffusion process 440 is applied to noisy features 435 to gradually remove the noise from noisy features 435 at the various noise levels to obtain denoised image features 445 (e.g., intermediate noise states) in latent space 425. In some cases, reverse diffusion process 440 is implemented as the reverse diffusion process described with reference to FIG. 9. In some cases, reverse diffusion process 440 is implemented by a generative machine learning model (such as the generative machine learning model described with reference to FIGS. 3, 7, and 11). In some cases, reverse diffusion process 440 is implemented by a U-Net ANN included in the generative machine learning model (such as the U-Net ANN described with reference to FIG. 5).

According to some aspects, a training component (such as the training component described with reference to FIGS. 3 and 11) compares denoised image features 445 to original image features 420 at each of the various noise levels, and updates image generative parameters of the generative machine learning model based on the comparison. In some cases, image decoder 450 decodes denoised image features 445 to obtain output image 455 (e.g., a synthetic image) in pixel space 410. In some cases, an output image 455 is created at each of the various noise levels. In some cases, the training component compares output image 455 to original image 405 to train the generative machine learning model.

In some cases, image encoder 415 and image decoder 450 are pretrained prior to training the generative machine learning model. In some examples, image encoder 415, image decoder 450, and the generative machine learning model are jointly trained. In some cases, image encoder 415 and image decoder 450 are jointly fine-tuned with the generative machine learning model.

According to some aspects, reverse diffusion process 440 is guided based on a guidance prompt such as prompt 460 (e.g., an input prompt or a training prompt). In some cases, prompt 460 is encoded using encoder 465 to obtain guidance features 470 in guidance space 475. In some cases, guidance features 470 are combined with noisy features 435 at one or more layers of reverse diffusion process 440 to encourage output image 455 to include content described by prompt 460, or to indicate regions in which diffusion is to occur. For example, guidance features 470 can be combined with noisy features 435 using a cross-attention block within reverse diffusion process 440.

Cross-attention, also known as multi-head attention, is an extension of the attention mechanism used in some ANNs for NLP tasks. In some cases, cross-attention enables reverse diffusion process 440 to attend to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences (such as a relative position of an objective text and a text prompt within prompt 460), allowing reverse diffusion process 440 to understand the context and generate more accurate and contextually relevant outputs.

According to some aspects, image encoder 415 and image decoder 450 are omitted, and forward diffusion process 430 and reverse diffusion process 440 occur in pixel space 410. For example, in some cases, forward diffusion process 430 adds noise to original image 405 to obtain noisy images (e.g., intermediate noise states) in pixel space 410, rather than noisy image features in a latent space, and reverse diffusion process 440 gradually removes noise from the noisy images to obtain output image 455 in pixel space 410.

FIG. 5 shows an example of a U-Net 500 according to aspects of the present disclosure. The example shown includes U-Net 500, input features 505, initial neural network layer 510, intermediate features 515, down-sampling layer 520, down-sampled features 525, up-sampling process 530, up-sampled features 535, skip connection 540, final neural network layer 545, and output features 550.

According to some aspects, a generative machine learning model (such as the generative machine learning model described with reference to FIGS. 3-4, 7, and 11) comprises an ANN architecture known as a U-Net. In some cases, U-Net 500 implements the reverse diffusion process described with reference to FIG. 9.

According to some aspects, U-Net 500 receives input features 505, where input features 505 include an initial resolution and an initial number of channels, and processes input features 505 using an initial neural network layer 510 (e.g., a convolutional neural network layer) to produce intermediate features 515.

In some cases, intermediate features 515 are then down-sampled using a down-sampling layer 520 such that down-sampled features 525 have a resolution less than the initial resolution and a number of channels greater than the initial number of channels.

In some cases, this process is repeated multiple times, and then the process is reversed. For example, down-sampled features 525 are up-sampled using up-sampling process 530 (or an up-sampling layer) to obtain up-sampled features 535. In some cases, up-sampled features 535 are combined with intermediate features 515 having a same resolution and number of channels via skip connection 540. In some cases, the combination of intermediate features 515 and up-sampled features 535 are processed using final neural network layer 545 to produce output features 550. In some cases, output features 550 have the same resolution as the initial resolution and the same number of channels as the initial number of channels.

According to some aspects, U-Net 500 receives additional input features to produce a conditionally generated output. In some cases, the additional input features include a vector representation of an input prompt. In some cases, the additional input features are combined with intermediate features 515 within U-Net 500 at one or more layers. For example, in some cases, a cross-attention module is used to combine the additional input features and intermediate features 515.

FIG. 6 shows an example of a transformer 600 included in a generative machine learning model (such as the generative machine learning model described with reference to FIGS. 3, 7, and 11) according to aspects of the present disclosure. The example shown includes transformer 600, encoder 605, decoder 620, input 640, input embedding 645, input positional encoding 650, previous output 655, previous output embedding 660, previous output positional encoding 665, and output 670.

In some cases, encoder 605 includes multi-head self-attention sublayer 610 and feed-forward network sublayer 615. In some cases, decoder 620 includes first multi-head self-attention sublayer 625, second multi-head self-attention sublayer 630, and feed-forward network sublayer 635.

In some cases, encoder 605 is configured to map input 640 (for example, an input prompt) to a sequence of continuous representations that are fed into decoder 620. In some cases, decoder 620 generates output 670 (e.g., a prediction of an output sequence of words or tokens) based on the output of encoder 605 and previous output 655 (e.g., a previously predicted output sequence), which allows for the use of autoregression.

For example, in some cases, encoder 605 parses input 640 into tokens and vectorizes the parsed tokens to obtain input embedding 645, and adds input positional encoding 650 (e.g., positional encoding vectors for input 640 of a same dimension as input embedding 645) to input embedding 645. In some cases, input positional encoding 650 includes information about relative positions of words or tokens in input 640.

In some cases, encoder 605 comprises one or more encoding layers (e.g., six encoding layers) that generate contextualized token representations, where each representation corresponds to a token that combines information from other input tokens via self-attention mechanism. In some cases, each encoding layer of encoder 605 comprises a multi-head self-attention sublayer (e.g., multi-head self-attention sublayer 610). In some cases, the multi-head self-attention sublayer implements a multi-head self-attention mechanism that receives different linearly projected versions of queries, keys, and values to produce outputs in parallel. In some cases, each encoding layer of encoder 605 also includes a fully connected feed-forward network sublayer (e.g., feed-forward network sublayer 615) comprising two linear transformations surrounding a Rectified Linear Unit (ReLU) activation:

$$F F N ( x ) = R e L U ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 640.

In some cases, each sublayer of encoder 605 is followed by a normalization layer that normalizes a sum computed between a sublayer input x and an output sublayer(x) generated by the sublayer:

$$l a y e r n o r m ( x + s u b l a y e r ( x ) ) \qquad ( 2 )$$

In some cases, encoder 605 is bidirectional because encoder 605 attends to each word or token in input 640 regardless of a position of the word or token in input 640.

In some cases, decoder 620 comprises one or more decoding layers (e.g., six decoding layers). In some cases, each decoding layer comprises three sublayers including a first multi-head self-attention sublayer (e.g., first multi-head self-attention sublayer 625), a second multi-head self-attention sublayer (e.g., second multi-head self-attention sublayer 630), and a feed-forward network sublayer (e.g., feed-forward network sublayer 635). In some cases, each sublayer of decoder 620 is followed by a normalization layer that normalizes a sum computed between a sublayer input x and an output sublayer(x) generated by the sublayer.

In some cases, decoder 620 generates previous output embedding 660 of previous output 655 and adds previous output positional encoding 665 (e.g., position information for words or tokens in previous output 655) to previous output embedding 660. In some cases, each first multi-head self-attention sublayer receives the combination of previous output embedding 660 and previous output positional encoding 665 and applies a multi-head self-attention mechanism to the combination. In some cases, for each word in an input sequence, each first multi-head self-attention sublayer of decoder 620 attends only to words preceding the word in the sequence, and so a prediction of transformer 600 for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 605 by receiving a query Q from a previous sublayer of decoder 620 and a key K and a value V from the output of encoder 605, allowing decoder 620 to attend to each word in the input 640.

In some cases, each feed-forward network sublayer implements a fully connected feed-forward network similar to feed-forward network sublayer 615. In some cases, the feed-forward network sublayers are followed by a linear transformation and a softmax to generate a prediction of output 670 (e.g., a prediction of a next word or token in a sequence of words or tokens).

FIG. 7 shows an example of data flow in a generative system 700 according to aspects of the present disclosure. The example shown includes generative system 700, input prompt 720, complexity value 725, resource allocation 730, and synthetic output 735. Generative system 700 is an example of, or includes aspects of, the corresponding element described with reference to FIGS. 1 and 11.

In one aspect, generative system 700 includes classifier network 705, allocation component 710, and generative machine learning model 715. Classifier network 705 is an example of, or includes aspects of, the corresponding element described with reference to FIGS. 3 and 11. Allocation component 710 is an example of, or includes aspects of, the corresponding element described with reference to FIG. 3. Generative machine learning model 715 is an example of, or includes aspects of, the corresponding element described with reference to FIGS. 3 and 11.

Referring to FIG. 7, according to some aspects, at inference time, generative system 700 generates synthetic output 735 based on input prompt 720. For example, in some cases, classifier network 705 generates complexity value 725 based on input prompt 720 as described with reference to FIG. 8. In some cases, allocation component 710 determines resource allocation 730 based on complexity value 725 as described with reference to FIG. 8. In some cases, generative machine learning model 715 generates synthetic output 735 based on input prompt 720 and according to resource allocation 730 as described with reference to FIG. 8.

### Generative Machine Learning

A method for generative machine learning is described with reference to FIGS. 8-9. One or more aspects of the method include obtaining an input prompt; generating, using a classifier network, a complexity value of the input prompt, wherein the complexity value corresponds to an amount of resources for a generative machine learning model to achieve a target quality level based on the input prompt; allocating resources of a generative machine learning model based on the complexity value; and generating, using the generative machine learning model, a synthetic output based on the input prompt using the allocated resources, wherein the synthetic output has the target quality level.

In some examples, allocating the resources comprises determining a diffusion time step based on the complexity value. In some examples, generating the synthetic output comprises performing a diffusion process based on a noise input, the input prompt, and the diffusion time step.

In some examples, allocating the resources comprises determining a size of the generative machine learning model. In some examples, allocating the resources comprises selecting the generative machine learning model from among a plurality of candidate machine learning models. In some examples, allocating the resources comprises selecting a processor for generating the synthetic output.

In some aspects, the generative machine learning model comprises an image generation model, and the synthetic output comprises an image that depicts an element described by the input prompt. In some aspects, the classifier network is trained by determining a quality of an output of the generative machine learning model.

FIG. 8 shows an example of a method 800 for generating a synthetic output according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 8, according to some aspects, a generative system (such as the generative system described with reference to FIGS. 1, 7, and 11) generates a synthetic output (such as an image, text, audio, video, or a combination thereof) based on an input prompt using a generative machine learning model. In some cases, the generative system determines a complexity of the input prompt, and generates the synthetic output using resources that are commensurate with the complexity. Accordingly, the generative system minimizes a number or amount of resources used for generating the synthetic output, thereby increasing an efficiency of the generative process, without compromising the quality of the synthetic output.

At operation 805, the system obtains an input prompt. In some cases, the operations of this step refer to, or may be performed by, a user interface as described with reference to FIG. 3. In some cases, the input prompt is provided by a user (such as the user described with reference to FIG. 1) to a generative apparatus (such as the generative apparatus described with reference to FIGS. 1, 3, and 13). In some cases, the user provides the input prompt to the generative apparatus via a user interface (such as the user interface described with reference to FIG. 3) provided on a user device (such as the user device described with reference to FIG. 1) by the generative apparatus. In some cases, the user interface comprises a graphical user interface, a text-based user interface, or a combination thereof. In some cases, the generative apparatus retrieves the input prompt from a database (such as the database described with reference to FIG. 1) or another data source (such as a website).

According to some aspects, the input prompt comprises a text string. According to some aspects, the input prompt comprises an image. According to some aspects, the input prompt comprises audio. According to some aspects, the input prompt comprises video.

At operation 810, the system generates, using a classifier network, a complexity value of the input prompt. In some cases, the operations of this step refer to, or may be performed by, a classifier network as described with reference to FIGS. 3, 7, and 11. According to some aspects, the classifier network is trained as described with reference to FIGS. 10-12.

The complexity value corresponds to an amount of resources for a generative machine learning model to achieve a target quality level based on the input prompt. In some cases, the complexity value can indicate a complexity of the prompt itself, or a complexity of a process for generating an output having a target quality level based on the prompt. For example, the resources needed for generating the target quality level of an output is correlated with one or more aspects of the prompt, such as a number of elements in the prompt, or complex relationships among elements in the prompt. In some cases, the complexity values can be learned using a machine learning process by evaluating the quality of different outputs given different kinds of prompts.

According to some aspects, the generative system obtains a set of input prompts. In some cases, the classifier network generates a complexity value for the set of input prompts. In some cases, the classifier network generates the complexity value in response to receiving the input prompt as input. In some cases, the complexity value comprises an indication of resources to use to generate a synthetic output based on the input prompt. In some cases, for example, the complexity value comprises a label.

In some cases, the resources of the generative machine learning model include a particular number of generative steps (or a particular generative time step), such as diffusion time steps of a reverse diffusion process. In some cases, the resources of the generative machine learning model relate to computing power. For example, in some cases, the resources of the generative machine learning model include a number of processors (such as the plurality of processors described with reference to FIG. 3) to be used to generate the synthetic output. In some cases, the resources of the generative machine learning model relate to a network size or parameters of the generative machine learning model. For example, in some cases, the resources of the generative machine learning model include a number of layers of the generative machine learning model to be used to generate the synthetic output. In some cases, the resources of the generative machine learning model relate to a selection of the generative machine learning model from among a set of candidate machine learning models. For example, in some cases, the set of candidate machine learning models comprise a set of image generation models comprising, e.g., a GAN and a diffusion model, and the complexity value is an identification of one of the set of image generation models to be used to generate the synthetic output.

At operation 815, the system allocates resources of a generative machine learning model based on the complexity value. In some cases, the operations of this step refer to, or may be performed by, an allocation component as described with reference to FIGS. 3 and 7.

In some cases, where the complexity value indicates a particular number of generative steps, such as diffusion time steps of a reverse diffusion process the allocation component instructs the generative machine learning model to use the particular number of generative steps to generate the synthetic output (for example, by updating parameters and/or hyperparameters of the generative machine learning model). In some cases, allocating the resources comprise determining a diffusion time step based on the complexity value.

In some cases, where the complexity value indicates a number of processors, the allocation component instructs the generative machine learning model to use the indicated number of processors to generate the synthetic output (for example, by updating parameters and/or hyperparameters of the generative machine learning model). In some cases, allocating the resources comprises selecting a processor for generating the synthetic output.

In some cases, where the complexity value indicates a network size or parameters of the generative machine learning model, the allocation component instructs the generative machine learning model to use the indicated number of layers or the indicated parameters to generate the synthetic output (for example, by updating parameters and/or hyperparameters of the generative machine learning model). In some cases, allocating the resources comprises determining a size of the generative machine learning model. In some cases, allocating the resources comprises selecting the generative machine learning model from among the set of candidate machine learning models.

At operation 820, the system generates, using the generative machine learning model, a synthetic output based on the input prompt using the allocated resources. In some cases, the operations of this step refer to, or may be performed by, a generative machine learning model as described with reference to FIGS. 3, 7, and 11. In some cases, the synthetic output has the target quality level. According to some aspects, the generative system provides the synthetic output via the user interface provided on the user device.

In some cases, where the allocated resources comprise a particular number of generative steps, such as diffusion time steps of a reverse diffusion process, the generative machine learning model generates the synthetic output using the particular number of generative steps or amount of time. In some cases, generating the synthetic output includes performing a diffusion process based on a noise input, the input prompt, and the diffusion time step to generate a synthetic image depicting an element described by the input prompt as described with reference to FIGS. 4 and 9.

In some cases, where the allocated resources comprise a number of processors, the generative machine learning model uses the indicated number of processors to generate the synthetic output. In some cases, where the allocated resources comprises a selected processor, the generative machine learning model generates the synthetic output using the selected processor.

In some cases, where the allocated resources comprise a network size or parameters of the generative machine learning model, the generative machine learning model generates the synthetic output using the network size or parameters. In some cases, where the allocated resources comprise a selection of the generative machine learning model from among the set of candidate machine learning models, the generative machine learning model generates the synthetic output in response to the selection.

According to some aspects, the generative machine learning model respectively generates a set of synthetic outputs for the set of input prompts in a single batch based on the common complexity value, thereby maintaining overall quality of the synthetic outputs while decreasing overall latency and increasing overall throughput of the generative system.

FIG. 9 shows an example 900 of diffusion processes according to aspects of the present disclosure. The example shown includes forward diffusion process 905 (such as the forward diffusion process described with reference to FIG. 4) and reverse diffusion process 910 (such as the reverse diffusion process described with reference to FIG. 4). In some cases, forward diffusion process 905 adds noise to an image or image features (e.g., original image 930 in a pixel space or image features for original image 930 in a latent space) to obtain a noise state 915 (e.g., a noisy image or a noisy image features. In some cases, reverse diffusion process 910 denoises the noise state 915 to obtain an intermediate noise state (e.g., first intermediate noise state 920 or second intermediate noise state 925) and a prediction of the original image 930.

According to some aspects, a generative apparatus (such as the generative apparatus described with reference to FIGS. 1, 3, and 13) uses forward diffusion process 905 to iteratively add Gaussian noise to an input at each diffusion time step t according to a known variance schedule 0<β₁<β₂< . . . <β_{T}<1:

$$q ( {x}_{t} \vert {x}_{t - 1} ) = 𝒩 ( {x}_{t} ; \sqrt{1 - {β}_{t}} {x}_{t - 1} , {β}_{t} I ) \qquad ( 3 )$$

According to some aspects, the Gaussian noise is drawn from a Gaussian distribution with mean μₜ=\sqrt{1−βₜ}xₜ₋₁ and variance σ²=βₜ≥1 by sampling ∈˜ [symbol] (0, I) and setting xₜ=\sqrt{1−βₜ}xₜ₋₁+\sqrt{βₜ}∈. Accordingly, beginning with an initial input x₀, forward diffusion process 905 produces x₁, . . . , ×ₜ, . . . x_{T}, where x_{T} is pure Gaussian noise. In some cases, T is a diffusion time step indicated by a complexity value and is a resource allocated as described with reference to FIG. 8.

In some cases, an observed variable x₀ (such as original image 930) is mapped in either a pixel space or a latent space to intermediate variables x₁, . . . , x_{T} using a Markov chain, where the intermediate variables x₁, . . . , x_{T} have a same dimensionality as the observed variable x₀. In some cases, the Markov chain gradually adds Gaussian noise to the observed variable x₀ or to the intermediate variables x₁, . . . , x_{T}, respectively, to obtain an approximate posterior q(x_{1:T}|x₀).

According to some aspects, during reverse diffusion process 910, a diffusion model (such as the generative machine learning model described with reference to FIGS. 3-5, 7, and 11) gradually removes noise from x_{T} to obtain a prediction of the observed variable x₀ (e.g., a representation of what the diffusion model predicts the original image 930 should be). In some cases, the prediction is influenced by a guidance prompt or a guidance vector (for example, an input prompt, training prompt, or a prompt embedding described with reference to FIG. 4). A conditional distribution p(xₜ₋₁|xₜ) of the observed variable x₀ is unknown to the diffusion model, however, as calculating the conditional distribution would require a knowledge of a distribution of all possible images. Accordingly, the diffusion model is trained to approximate (e.g., learn) a conditional probability distribution p_{θ}(xₜ₋₁|xₜ) of the conditional distribution p(xₜ₋₁|xₜ):

$${p}_{θ} ( {x}_{t - 1} \vert {x}_{t} ) = N ( {x}_{t - 1} ; {μ}_{θ} ( {x}_{t} , t ) , {\sum }_{θ} ( {x}_{t} , t ) ) \qquad ( 4 )$$

In some cases, a mean of the conditional probability distribution p_{θ}(xₜ₋₁|xₜ) is parameterized by μ_{θ} and a variance of the conditional probability distribution p_{θ}(xₜ₋₁|xₜ) is parameterized by Σ_{θ}. In some cases, the mean and the variance are conditioned on a noise level t (e.g., an amount of noise corresponding to a diffusion time step t). According to some aspects, the diffusion model is trained to learn the mean and/or the variance.

According to some aspects, the diffusion model initiates reverse diffusion process 910 with noisy data x_{T} (such as noise state 915). According to some aspects, the diffusion model iteratively denoises the noisy data x_{T} to obtain the conditional probability distribution p_{θ}(xₜ₋₁|xₜ). For example, in some cases, at each step t−1 of reverse diffusion process 910, the diffusion model takes xₜ (such as first intermediate noise state 920) and t as input, where t represents a step in a sequence of transitions associated with different noise levels, and iteratively outputs a prediction of xₜ₋₁ (such as second intermediate noise state 925) until the noisy data x_{T} is reverted to a prediction of the observed variable x₀ (e.g., a predicted image for original image 930).

According to some aspects, a joint probability of a sequence of samples in the Markov chain is determined as a product of conditionals and a marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 5 )$$

In some cases, p(x_{T})= [symbol] (x_{T}; 0, I) is a pure noise distribution, as reverse diffusion process 910 takes an outcome of forward diffusion process 905 (e.g., a sample of pure noise x_{T}) as input, and

$${\prod }_{t = 1}^{T} {p}_{θ} ( {x}_{t - 1} \vert {x}_{t} )$$

represents a sequence of Gaussian transitions corresponding to a sequence of addition of Gaussian noise to a sample. In some cases, each of forward diffusion process 905 and reverse diffusion process 910 include an equal number of T steps.

### Training

A method for training a machine learning model is described with reference to FIGS. 10-12. One or more aspects of the method include obtaining a training set including a training prompt; generating, using a generative machine learning model, a synthetic output based on the training prompt; and training, using the training set and the synthetic output, a classifier network to generate a complexity value based on an input prompt.

Some examples of the method further include determining a quality value of the synthetic output, wherein the classifier network is trained based on the quality value. In some examples, determining the quality value comprises comparing the synthetic output to a ground-truth media asset.

Some examples of the method further include generating a plurality of synthetic outputs based on the training prompt using a plurality of different resource allocations, respectively. Some examples further include selecting a target resource allocation from among the plurality of different resource allocations based on the plurality of synthetic outputs, wherein the classifier network is trained based on the target resource allocation.

In some aspects, the target resource allocation comprises a diffusion time step, a processor, a network size, or any combination thereof. In some examples, selecting the target resource allocation comprises generating the plurality of synthetic outputs until a quality condition is satisfied, wherein the target resource allocation is selected based on resources allocated to the generative machine learning model when the quality condition is satisfied.

Some examples of the method further include determining a training complexity value based on the target resource allocation. In some examples, training the classifier network comprises generating, using the classifier network, a predicted complexity value based on the training prompt. In some examples, training the classifier network further comprises comparing the predicted complexity value to a ground-truth complexity value for the training prompt.

FIG. 10 shows an example of a method 1000 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 10, in some cases, a generative system (such as the generative system described with reference to FIGS. 1, 7, and 11) trains a classifier network (such as the classifier network described with reference to FIGS. 3, 7, and 11) to generate a complexity value of an input prompt. In some cases, the classifier network is trained based on a synthetic output generated by a generative machine learning model (such as the generative machine learning model described with reference to FIGS. 3, 11, and 7).

At operation 1005, the system obtains a training set including a training prompt. In some cases, the operations of this step refer to, or may be performed by, a training component as described with reference to FIGS. 3 and 11. For example, in some cases, the training component retrieves the training set from a database (such as the database described with reference to FIG. 1) or from another data source (such as the Internet). In some cases, a user provides the training set to the training component via a user interface provided on a user device by the generative system. In some cases, the training prompt comprises text, an image, audio, video, or a combination thereof. In some cases, the training prompt comprises text describing an element of an image.

At operation 1010, the system generates, using a generative machine learning model, a synthetic output based on the training prompt. In some cases, the operations of this step refer to, or may be performed by, a generative machine learning model as described with reference to FIGS. 3, 7, and 11. For example, in some cases, the generative machine learning model generates the synthetic output using a generative process guided by the input prompt. In some cases, the synthetic output includes an element described by the input prompt. In some cases, the synthetic output is an image, and the generative process used to generate the synthetic output is an image generation process (e.g., a diffusion process, such as the diffusion process described with reference to FIG. 9).

According to some aspects, the generative machine learning model generates a set of synthetic outputs based on the training prompt using a set of different resource allocations, respectively. In some cases, the set of different resource allocations include different diffusion time steps of a diffusion process, different processors of a set of processors (e.g., of the plurality of processors described with reference to FIG. 3), different numbers of processors (e.g., of the plurality of processors described with reference to FIG. 3), different network sizes of the generative machine learning model, different selected generative machine learning models of a set of generative machine learning models, or any combination thereof.

In an example, the generative machine learning model generates a set of synthetic outputs including a set of images respectively generated at each diffusion time step of a reverse diffusion process as described with reference to FIG. 9, where each diffusion time step is a different resource allocation of the set of different resource allocations.

At operation 1015, the system trains, using the training set and the synthetic output, a classifier network to generate a complexity value based on an input prompt. In some cases, the operations of this step refer to, or may be performed by, a training component as described with reference to FIGS. 3 and 11. For example, in some cases, the trained classifier network will generate the complexity value based on the input prompt. According to some aspects, the complexity value corresponds to an amount of resources for the generative machine learning model to achieve a target quality level based on the input prompt.

According to some aspects, the training component determines a quality value of the synthetic output. In some cases, the training component determines the quality value by comparing the synthetic output to a ground-truth media asset. In some cases, the quality value comprises a difference between the synthetic output and the ground-truth media asset. In some cases, a lower quality value indicates a greater similarity between the synthetic output and the ground-truth media asset. In some cases, an encoder (such as the encoder described with reference to FIG. 3) generates an embedding for each of the synthetic output and the ground-truth media asset, where the quality value is a distance (e.g., a Euclidean distance or other distance metric) between the embeddings.

In some cases, the generative machine learning model generates the ground-truth media asset based on the training prompt. In some cases, the ground-truth media asset is included in the training set. In some cases, the ground-truth media asset and the synthetic output comprise a common modality (e.g., text, image, audio, or video).

In an example, the training component determines a quality value by comparing a synthetic output comprising a synthetic image generated based on a training prompt at a diffusion time step of a diffusion process performed by the generative machine learning model, where the training prompt comprises a text description of an image to be generated, and a ground-truth media asset comprising an image generated by the generative machine learning model based on the training prompt at a predetermined diffusion time step of a reverse diffusion process (e.g., a 50^{th} diffusion time step).

In the example, the training component comprises one or more of a Frechet inception distance (FID) model and a learned perceptual image patch similarity (LPIPS) model, and the quality value comprises a distance determined according to one or more of the FID model and the LPIPS model.

In the example, the FID model calculates a quality value d based on respective feature vectors of the synthetic output and the ground-truth media asset according to equation 6:

$${d}^{2} = {‖ {μ}_{1} - {μ}_{2} ‖}^{2} + T r ( {C}_{1} + {C}_{2} - 2 \sqrt{{C}_{1} \cdot {C}_{2}} ) \qquad ( 6 )$$

In some cases, μ₁ is a feature-wise mean of the ground-truth media asset, μ₂ is a feature-wise mean of the synthetic output, ∥μ₁−μ₂∥² is a sum squared difference between the ground-truth media asset feature vector and the synthetic output feature vector, C₁ is a covariance matrix for the ground-truth media asset feature vector, C₂ is a covariance matrix for the synthetic output feature vector, \sqrt{C₁·C₂} is a square root of a square matrix of a product between C₁ and C₂, and Tr is a trace linear algebra operation.

In the example, the LPIPS model uses a convolution neural network (CNN) to compute respective feature vectors for the ground-truth media asset x and the synthetic output x₀, extracts a feature stack from layers of the CNN, unit-normalizes activations of the layers in a channel dimension (designated as ŷ^{l}, ŷ₀^{l}∈ [symbol] ^{H}^{ₗ}^{×W}^{ₗ}^{×C}^{ₗ} for layer l), scaling the activations channel-wise by vector w^{l}∈ [symbol] ^{C}^{ₗ}, and computing the [symbol] ₂ distance to obtain the quality value d:

$$d ( x , {x}_{0} ) = {\sum }_{l} \frac{1}{{H}_{l} {W}_{l}} {\sum }_{h , w} {‖ {w}_{l} ⊙ ( {\hat{y}}_{h w}^{l} - {\hat{y}}_{0 h w}^{l} ) ‖}_{2}^{2} \qquad ( 7 )$$

According to some aspects, the training component selects a target resource allocation (e.g., a diffusion time step, a processor, a network size, or any combination thereof) from among the set of different resource allocations based on the set of synthetic outputs. For example, in some cases, the training component determines the target resource allocation by comparing the set of different resource allocations with the set of quality values respectively determined for the set of synthetic outputs respectively generated using the set of different resource allocations.

In an example, given the set of synthetic outputs comprising synthetic images generated at different diffusion time steps of a diffusion process (e.g., different resource allocations) based on a training prompt, and a respectively corresponding set of quality values generated based on the set of synthetic outputs and the ground-truth media asset comprising the image generated based on the training prompt, the training component plots the set of quality values against the diffusion time steps at which the set of synthetic outputs corresponding to the set of quality values were generated to obtain a graph.

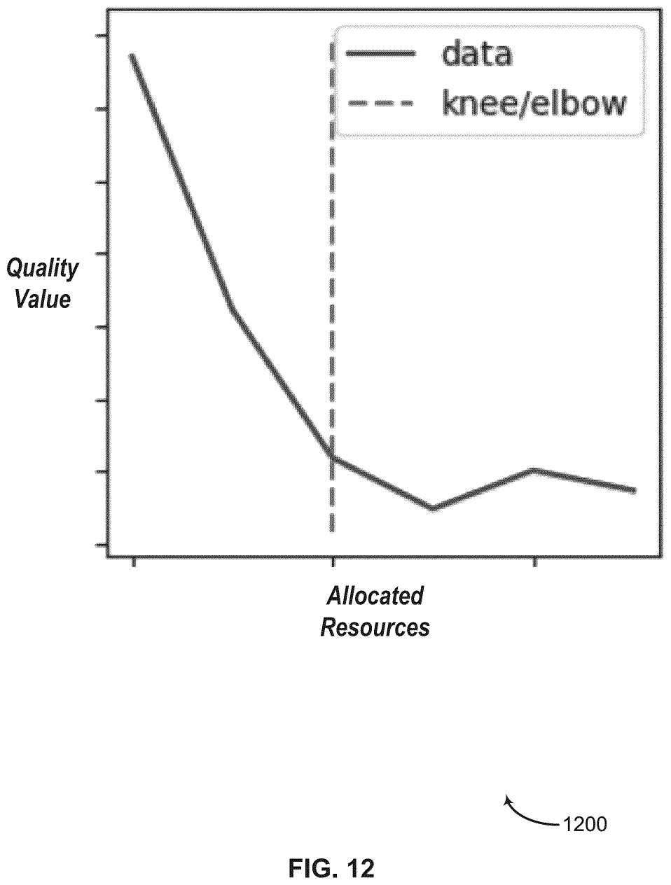

In some cases, the training component identifies, using the graph, an inflection point of diminishing returns at which an increased allocation of resources does not correspond to a significant reduction in quality value (e.g., a diffusion time step at which a difference between a synthetic output of the diffusion process and the ground-truth media asset is not significantly decreased from a previous diffusion time step), and identifies the resource allocation at the inflection point as the target resource allocation. In some cases, the training component determines the inflection point using a knee-point detection algorithm. An example of a graph is described with reference to FIG. 12.

In some cases, the training component selects the target resource allocation using a fixed threshold. For example, in some cases, the training component determines a mean and variance of quality values among a set of ground-truth media assets, and uses the resource allocation corresponding to the mean quality value plus or minus the standard deviation as the target resource allocation.

In some cases, the generative machine learning model generates the set of synthetic outputs, and the training component determines a quality value and a corresponding resource allocation for each synthetic output as they are generated. In some cases, the generative machine learning model generates the set of synthetic outputs until the training component determines that a quality condition is satisfied (e.g., the inflection point or the fixed threshold is reached). In some cases, the training component selects the target resource allocation based on the resources allocated to the generative machine learning model when the quality condition is satisfied.

In some cases, the training component determines a training complexity value based on the target resource allocation. For example, in some cases, the training component generates the training complexity value based on the target resource allocation, where the training complexity value is a text or numerical indication of the target resource allocation. In an example, the training component determines that an n^{th} diffusion time step is a target resource allocation for a training prompt, and generates a training complexity value identifying the n^{th} diffusion time step as the target resource allocation.

According to some aspects, the classifier network generates a predicted complexity value based on the training prompt. In some cases, the training component compares the predicted complexity value to a ground-truth complexity value (e.g., the training complexity value) for the training prompt and trains the classifier network based on the comparison.

For example, in some cases, the training component calculates a loss based on the comparison, and updates the parameters of the classifier network based on the loss. A loss function refers to a function that impacts how a machine learning model is trained using supervised learning. In some cases, during each training iteration, an output of the machine learning model (e.g., the predicted complexity value) is compared to known information (e.g., the ground-truth complexity value). The loss function provides a value (the “loss”) for how close the output is to the known information. After computing the loss, the parameters of the model are updated accordingly and a new set of predictions are made during the next iteration, with the goal of causing the machine learning model to generate an output that is increasingly similar to the known information as the parameters are updated.

Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (e.g., a vector) and a desired output value (e.g., a single value or an output vector). In some cases, a supervised learning algorithm analyzes the training data and produces the inferred function, which can be used for mapping new examples. In some cases, the learning results in a function that correctly determines the class labels for unseen instances. For example, the learning algorithm generalizes from the training data to unseen examples. In some cases, the training component updates image generative parameters of the image generation model based on the loss.

In an example where an n^{th} diffusion time step is the ground-truth complexity value, the training component updates parameters of the classifier network until the classifier network generates a predicted complexity value indicating that the generative machine learning model should use up to the n^{th} diffusion time step to generate a synthetic output based on the training prompt. An example of data flow in the generative system for training the classifier network is described with reference to FIG. 11.

FIG. 11 shows an example of data flow for training a machine learning model according to aspects of the present disclosure. Generative system 1100 is an example of, or includes aspects of, the corresponding element described with reference to FIGS. 1 and 7. In one aspect, generative system 100 includes generative machine learning model 1105, training component 1110, and classifier network 1115.

Generative machine learning model 1105 is an example of, or includes aspects of, the corresponding element described with reference to FIGS. 3 and 7. Training component 1110 is an example of, or includes aspects of, the corresponding element described with reference to FIG. 3. Classifier network 1120 is an example of, or includes aspects of, the corresponding element described with reference to FIGS. 3 and 7.

Referring to FIG. 11, according to some aspects, generative machine learning model generates a synthetic output based on a training prompt as described with reference to FIG. 10. Training component 1110 compares the synthetic output with a ground-truth media asset to obtain a ground-truth complexity value (for example, by obtaining a target resource allocation based on a quality value) as described with reference to FIG. 10. In some cases, generative ML model 1105 generates the ground-truth media asset based on the training prompt using a different number of resources (e.g., a different number of diffusion time steps) than generative ML model 1105 uses to generate the synthetic output.

Classifier network 1115 generates a predicted complexity value based on the training prompt as described with reference to FIG. 10. Training component 1110 compares the predicted complexity value to the ground-truth complexity value to obtain a loss, and updates the parameters of classifier network 1115 according to the loss.

FIG. 12 shows an example of a graph 1200 of quality values versus resource allocations according to aspects of the present disclosure. Referring to FIG. 12, in some cases, a training component (such as the training component described with reference to FIGS. 3 and 11) generates a graph of a set of quality values versus a set of different resource allocations as described with reference to FIG. 10. In some cases, the quality values of the Y-axis of graph 1200 increase in value in a direction from the bottom of the Y-axis to the top of the Y-axis. In some cases, the different resource allocations of the X-axis of graph 1200 increase from the left of the X-axis to the right of the X-axis. For example, in some cases, the X-axis represents a left-to-right increase in diffusion time steps of a diffusion process, a number of processors, a size of a generative machine learning model, etc.

Graph 1200 shows that as allocated resources increase, quality values of corresponding synthetic outputs generated using the allocated resources decrease (indicating a decreasing difference or increasing similarity between the synthetic outputs and a ground-truth media asset). Graph 1200 shows a knee/elbow point (e.g., an inflection point) as a vertical dashed line, where the inflection point identifies a target resource allocation of the set of different resource allocations.

### Computing Device

FIG. 13 shows an example of a computing device according to aspects of the present disclosure. According to some aspects, computing device 1300 includes processor(s) 1305, memory subsystem 1310, communication interface 1315, I/O interface 1320, user interface component(s) 1325, and channel 1330.

In some embodiments, computing device 1300 is an example of, or includes aspects of, the generative apparatus described with reference to FIGS. 1 and 3-7. In some embodiments, computing device 1300 includes one or more processors 1305 that can execute instructions stored in memory subsystem 1310 to obtain an input prompt; generate, using a classifier network, a complexity value based on the input prompt; allocate resources of a generative machine learning model based on the complexity value; and generate, using the generative machine learning model, a synthetic output based on the input prompt using the allocated resources.

According to some aspects, computing device 1300 includes one or more processors 1305. Processor(s) 1305 are an example of, or includes aspects of, the processor unit as described with reference to FIG. 3, and in some cases the plurality of processors described with reference to FIG. 3. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1310 includes one or more memory devices. Memory subsystem 1310 is an example of, or includes aspects of, the memory unit as described with reference to FIG. 3. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS@, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI, a text-based user interface, or a combination thereof.

The description and drawings described herein represent example configurations and do not represent all the implementations within the scope of the claims. For example, the operations and steps may be rearranged, combined, or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for generative machine learning, comprising:
obtaining an input prompt;
generating, using a classifier network, a complexity value of the input prompt, wherein the complexity value corresponds to an amount of resources for a generative machine learning model to achieve a target quality level based on the input prompt;
allocating resources of the generative machine learning model based on the complexity value; and
generating, using the generative machine learning model, a synthetic output based on the input prompt using the allocated resources, wherein the synthetic output has the target quality level.

2. The method of claim 1, wherein allocating the resources comprises:
determining a diffusion time step based on the complexity value.

3. The method of claim 2, wherein generating the synthetic output comprises:
performing a diffusion process based on a noise input, the input prompt, and the diffusion time step.

4. The method of claim 1, wherein allocating the resources comprises:
determining a size of the generative machine learning model.

5. The method of claim 1, wherein allocating the resources comprises:
selecting the generative machine learning model from among a plurality of candidate machine learning models.

6. The method of claim 1, wherein allocating the resources comprises:
selecting a processor for generating the synthetic output.

7. The method of claim 1, wherein:
the generative machine learning model comprises an image generation model, and the synthetic output comprises an image that depicts an element described by the input prompt.

8. The method of claim 1, wherein:
the classifier network is trained by determining a quality of an output of the generative machine learning model.

9. A method for training a machine learning model, comprising:
obtaining a training set including a training prompt;
generating, using a generative machine learning model, a synthetic output based on the training prompt; and
training, using the training set and the synthetic output, a classifier network to generate a complexity value of an input prompt, wherein the complexity value corresponds to an amount of resources for the generative machine learning model to achieve a target quality level based on the input prompt.

10. The method of claim 9, further comprising:
determining a quality value of the synthetic output, wherein the classifier network is trained based on the quality value.

11. The method of claim 10, wherein determining the quality value comprises:
comparing the synthetic output to a ground-truth media asset.

12. The method of claim 9, further comprising:
generating a plurality of synthetic outputs based on the training prompt using a plurality of different resource allocations, respectively; and
selecting a target resource allocation from among the plurality of different resource allocations based on the plurality of synthetic outputs, wherein the classifier network is trained based on the target resource allocation.

13. The method of claim 12, wherein:
the target resource allocation comprises a diffusion time step, a processor, a network size, or any combination thereof.

14. The method of claim 12, wherein selecting the target resource allocation comprises:
generating the plurality of synthetic outputs until a quality condition is satisfied, wherein the target resource allocation is selected based on resources allocated to the generative machine learning model when the quality condition is satisfied.

15. The method of claim 12, further comprising:
determining a training complexity value based on the target resource allocation.

16. The method of claim 9, wherein training the classifier network comprises:
generating, using the classifier network, a predicted complexity value based on the training prompt; and
comparing the predicted complexity value to a ground-truth complexity value for the training prompt.

17. A system for generative machine learning, comprising:
at least one memory;
at least one processor executing instructions stored in the at least one memory;
a classifier network comprising classification parameters stored in the at least one memory, the classifier network trained to generate a complexity value of an input prompt, wherein the complexity value corresponds to an amount of resources to achieve a target quality level based on the input prompt;
an allocation component configured to allocate resources based on the complexity value; and
a generative machine learning model comprising generative parameters stored in the at least one memory, the generative machine learning model trained to generate a synthetic output based on the input prompt using the allocated resources, wherein the synthetic output has the target quality level.

18. The system of claim 17, wherein:
the generative machine learning model comprises an image generation model, and the allocated resources comprise a number of image generation steps.

19. The system of claim 17, wherein:
the generative machine learning model comprises a configurable number of parameters, wherein the allocated resources indicates a value for the configurable number of parameters.

20. The system of claim 17, the system further comprising:
a plurality of processors, wherein the allocated resources comprises one or more of the plurality of processors.
